(19) United States
(12) Patent Application Publication
(10) Pub. No.: US 2026/0073481 A1
(43) Pub. Date: Mar. 12, 2026

(54) Self-Trained Neural Network for Noise Reduction in Computed Tomography

(71) Applicant: Mayo Foundation for Medical Education and Research, Rochester, MN (US)

(72) Inventors: Cynthia H. McCollough, Byron, MN (US); Lifeng Yu, Byron, MN (US); Zhongxing Zhou, Rochester, MN (US)

(21) Appl. No.: 18/873,086

(22) PCT Filed: Jun. 9, 2023
(86) PCT No.: PCT/US2023/068243

§ 371 Date: Dec. 9, 2024

Related U.S. Application Data
(60) Provisional application No. 63/350,958, filed on Jun. 10, 2022.

(51) Int. Cl. G06T 5/60; G06T 5/70; G06T 11/00

(52) U.S. Cl. CPC G06T 5/60; G06T 5/70; G06T 12/20; G06T 2207/10081; G06T 2207/20081; G06T 2207/20084; G06T 2207/30004; G06T 2210/41; G06T 2211/441

(57) ABSTRACT

Noise-reduced images of a subject are generated from x-ray projection data acquired from the subject using a computed tomography (“CT”) system. A neural network or other machine learning algorithm is trained to receive images reconstructed from the projection data as an input and to generate an output as noise-reduced images. The neural network or other machine learning algorithm is trained using a self-training procedure, in which the training data used to train the neural network or other machine learning algorithm are generated directly from the projection data acquired from the subject using data augmentation (e.g., random rotations of the projection data and/or noise insertion).

### BACKGROUND

Deep convolutional neural networks (“CNNs”) have been actively used in x-ray computed tomography (“CT”) for improving image quality. Various network architectures have been proposed to reduce image noise or enhance spatial resolution, and can be applied on projection data, during image reconstruction, or directly on images after reconstruction. Some of these methods have become commercially available either on CT scanners or as third-party products to improve image quality or reduce radiation dose. In general, deep CNN-based methods rely on the existence of a large amount of high-quality and low-quality data, either paired or un-paired, for training. However, these data may not always be available; thus, it would be advantageous to have other methods for training deep CNNs for improving CT image quality.

### SUMMARY OF THE DISCLOSURE

The present disclosure addresses the aforementioned drawbacks by providing a method for generating noise-reduced medical images. The method includes accessing projection data with a computer system, where the projection data include x-ray projection data acquired from a subject using a computed tomography (“CT”) system. Training data are generated from the projection data using the computer system. In general, generating the training data includes: generating a set of low-quality projection data by inserting noise to the projection data in different independent insertions; generating augmented low-quality projection data by applying a data augmentation technique to the low-quality projection data; reconstructing low-quality images from the augmented low-quality projection data; generating augmented projection data by applying the data augmentation technique to the projection data; and reconstructing high-quality images from the augmented projection data. These low-quality images and the high-quality images are stored as the training data. A neural network is then trained on the training data. Images of the subject are reconstructed from the projection data, and the reconstructed images of the subject are applied to the trained neural network, generating output as the noise-reduced images of the subject.

The foregoing and other aspects and advantages of the present disclosure will appear from the following description. In the description, reference is made to the accompanying drawings that form a part hereof, and in which there is shown by way of illustration one or more embodiments. These embodiments do not necessarily represent the full scope of the invention, however, and reference is therefore made to the claims and herein for interpreting the scope of the invention.

### BRIEF DESCRIPTION OF THE DRAWINGS

FIG. 1 is an overview of an example training scheme for self-training a neural network or other machine learning algorithm based on a single set of projection data acquired from a subject.

FIG. 2 is a flowchart setting forth the steps of an example method for generating noise-reduced images using a self-trained neural network according to some embodiments described in the present disclosure.

FIG. 3 is a flowchart setting forth the steps of an example method for generating low-quality (e.g., low-dose) images from projection data using random rotations and noise addition for use as part of a training data set.

FIG. 4 is a flowchart setting forth the steps of an example method for generating high-quality (e.g., high dose) images from projection data using random rotations (and optionally noise addition) for use as part of a training data set.

FIG. 5A illustrates an example architecture of a residual-based 2D CNN denoiser with 7 slices input, showing the global structure of the network as containing a 2D initial block, three 2D residual blocks, and a final block.

FIG. 5B illustrates details of the convolutional layers and transformations used within each block of the example residual-based 2D CNN denoiser model of FIG. 5A, where Conv2D=two-dimensional convolutional layer, N=arbitrary image size, ReLU=rectified linear units.

FIGS. 6A-6D show an example comparing filtered backprojection (FBP) and iterative reconstruction (IR) full dose (FD) images, as well as conventional (CNN) and self-trained (ST_CNN)-denoised FBP FD images from a patient case. The arrows point to two liver lesions. Slice thickness was 1 mm. To visualize the different appearance better, the display window was narrowed down to [60,200] HU.

FIG. 7A-7D show another example comparing the FBP and IR full dose (FD), conventional and self-trained CNN-denoised FBP FD images from a patient case. The arrows point to two liver lesions. Slice thickness was 1 mm. To visualize the different appearance better, the display window was narrowed down to [60,200] HU.

FIGS. 8A-8F show an example comparing the FBP and IR quarter dose (QD), FBP and IR full dose (FD), conventional and self-trained CNN-denoised QD images from a patient case. The arrows point to two liver lesions. A zoomed-in region of interest (ROI) within the center small box is shown in the bottom-right corner. Note the bottom arrow on the conventional CNN-denoised image points to a false positive lesion that does not exist on the self-trained CNN-denoised image. Slice thickness was 1 mm. To visualize the different appearance better, the display window was narrowed down to [60,200] HU.

FIG. 9 is a block diagram of an example system for generating noise-reduced images using a self-trained neural network in accordance with some embodiments described in the present disclosure.

FIG. 10 is a block diagram of example components that can implement the system of FIG. 9.

### DETAILED DESCRIPTION

Described here are systems and methods for generating noise-reduced images of a subject from x-ray projection data acquired from the subject using a computed tomography (“CT”) system. In general, a neural network or other machine learning algorithm is trained to receive images reconstructed from the projection data as an input and to generate an output as noise-reduced images. The neural network or other machine learning algorithm is trained using a self-training procedure in which training data are generated directly from the projection data acquired from the subject.

In general, the systems and methods described in the present disclosure train a neural network or other machine learning algorithm directly using the projection data itself through extensive data augmentation (e.g., random rotation and noise addition), and the inference is on the data itself as well. Using these self-trained neural networks can achieve similar, or better, performance than conventional deep convolutional neural network (“CNN”) denoising methods. There are at least three advantages of this technique.

As one advantage, by removing the need for a large number of pre-existing training data, the systems and methods described in the present disclosure can be applied to any CT data, even if the data conditions were not previously trained. Sufficient amount of data for training a neural network or other machine learning algorithm is an important factor contributing to supervised deep learning-based denoising. The systems and methods described in the present disclosure can accurately generate synthetic noisier sinograms from the original whole sinogram of a patient based on accurate noise model and data augmentation. Therefore, sufficient data can be generated for training even with single patient cases. As another advantage, the self-training mechanism eliminates the generalizability issue that may occur for network models applied to datasets that are different from the training datasets. As yet another advantage, the trained model can be applied to and fine-tuned for each individual patient if repeated CT exams are expected, which may maximize the benefit of image quality improvement and radiation dose reduction.

In the field of deep learning-based image processing, researchers have explored various self-supervised denoising methods that can be trained on individual noisy images. In these studies, the denoising models can be put into two categories: models trained on synthetic noisy images, or models trained directly on different subsets of features in the original images according to the inherent correlations among pixels. The denoising methods in the first category require the noise model to be known a priori to generate noisy images, while the methods in the second category are developed by assuming that the noise is zero-mean and independent among all dimensions. When the noise model or the assumption of zero-mean independent noise is not accurate, these self-supervised methods degrade sharply and are not competitive with traditional supervised deep image denoisers.

In the systems and methods described in the present disclosure, the synthetic noisy data can be accurately generated from the original data in the projection domain, from which paired clean and noisy images can be obtained after CT reconstruction. When only one individual projection dataset is available, a neural network can be trained directly using the data itself through extensive data augmentation (random rotation and noise addition) in the projection domain.

The self-trained deep CNN described in the present disclosure can be implemented as an image-domain supervised deep learning technique, but there is a distinct difference in the training scheme from existing approaches. The conventional supervised deep CNN methods are trained based on a large number of paired high-quality (e.g., high dose) and low-quality (e.g., low dose) data from a large number of patients and/or phantom images. The availability of sufficient amount of data for training is one important factor contributing to the performance of these previous methods. In addition, the model trained using conventional training techniques from one dataset may not generalize well to another dataset acquired or reconstructed at a different condition.

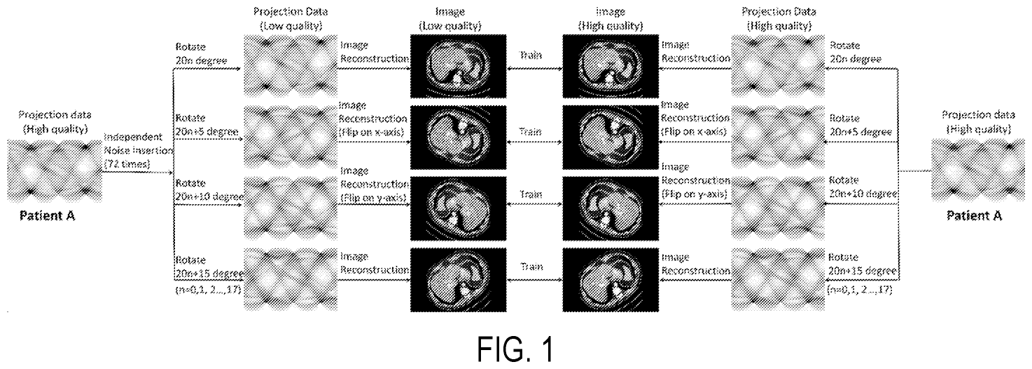

As noted above, the proposed self-trained neural network method is trained based on the data acquired from one single patient by generating a large amount of paired low-quality and high-quality images from the same patient, as illustrated in FIG. 1. The trained model is used to denoise the data acquired from the same patient.

Conventional deep CNN denoising in CT typically starts with noise insertion in routine-dose projection data to simulate the corresponding low-dose projection data. After noise insertion, paired images at low and routine dose are reconstructed with the same reconstruction parameters, which are used as input and target for supervised training for a CNN denoising model. The availability of a sufficient amount of patient cases for training is an important factor contributing to the performance of conventional CNN denoising methods. The loss function in a typical conventional deep CNN denoising model can be formulated as:

$$L = \frac{1}{M} {\sum }_{i = 1}^{M} {‖ F ( {x}_{i} ) - Q [ F ( N ( {x}_{i} ) ) ] ‖}_{α}$$

where x denotes the routine dose projection data, {(F(xᵢ),F(N(xᵢ)))}(i=1, 2, . . . , M) the training dataset composed of routine dose images and the corresponding low dose images from M patients, N(•) denotes noise insertion in projection domain, F(•) represents the CT reconstruction algorithm such as filtered backprojection (“FBP”), and Q(•) is the deep CNN network mapping low-dose to routine-dose images. The symbol α is related to the type of loss functions, for example, α=2 and α=1 stands for mean square error (“MSE”) loss and mean absolute error (“MAE”) loss, respectively.

As described above, the self-trained CNN methods described in the present disclosure are trained based on data acquired from one single patient by generating a large amount of paired low-quality and high-quality images from the same patient. The corresponding loss function may be formulated as:

$$L = \frac{1}{JK} {\sum }_{k = 1}^{K} {\sum }_{j = 1}^{J} {‖ F ( {R}^{( k )} x ) - Q [ F ( {R}^{( k )} {N}^{( j )} ( x ) ) ] ‖}_{α}$$

where {(F(R^{(k)}x),F(R^{(k)}N^{(j)}(x)))}(j=1, 2, . . . , J; k=1, 2, . . . , K) denotes the training dataset composed of routine dose image and the corresponding low dose image from K times rotation (or other data augmentation) and J times independent noise insertion of the projection data of a single patient, and where R is the rotation (or other data augmentation) in the projection domain.

### Neural Network Implementation

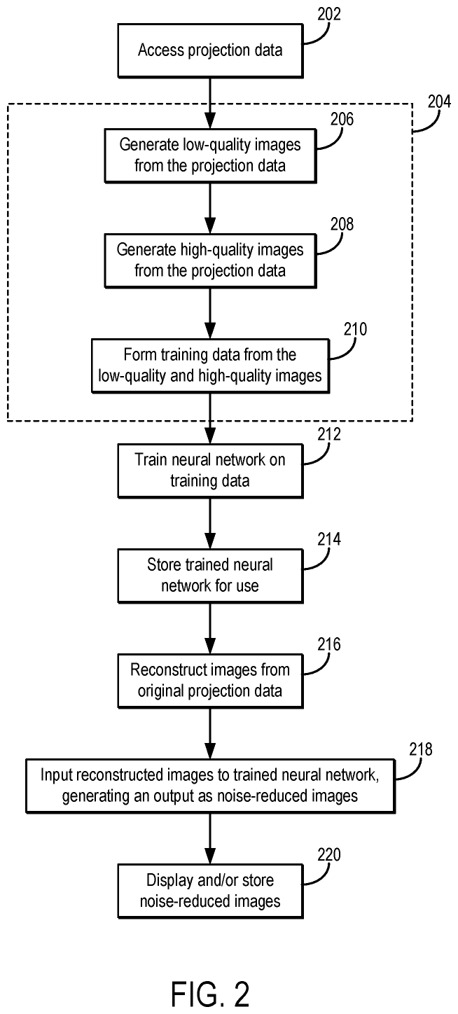

Referring now to FIG. 2, a flowchart is illustrated as setting forth the steps of an example method for denoising and/or reducing artifacts in CT images of a patient using a self-trained neural network or other machine learning algorithm. For simplicity, the method is described with respect to the training and implementation of a convolutional neural network. It will be appreciated, however, that other types of neural networks can also be trained and implemented, as can other machine learning algorithms, machine learning models, or AI models. Additionally, the technique is described for CT imaging; however, as described above it can be readily implemented for other medical imaging modalities.

The method includes accessing projection data with a computer system, as indicated at step 202. Accessing the projection data may include retrieving such data from a memory or other suitable data storage device or medium. Alternatively, accessing the projection data may include acquiring such data with a medical imaging system and transferring or otherwise communicating the data to the computer system, which may be a part of the medical imaging system. In general, the projection data includes x-ray projection data acquired with a CT imaging system from a subject, and includes data in which noise and/or artifacts are present.

Training data are then generated from the projection data, as indicated at process block 204. In general, the training data include a large amount of paired low-quality and high-quality images that are generated from the projection data. Thus, generating the training data includes generating low-quality images from the projection data, as indicated at step 206, and generating high-quality images from the projection data, as indicated at step 208.

In general, the training data include augmented image data that have been generated based on medical images reconstructed from the original projection data, such that a neural network or other machine learning algorithm can be trained using a self-training (e.g., self-supervised learning) approach. For instance, the training data can include noise-augmented image data that includes images reconstructed from the projection data after noise has been inserted into the projection data. Additionally or alternatively, the augmented image data can include images that have been rotated and/or translated, such as by applying rotations and/or translations to the projection data and reconstructing images from the augmented projection data.

### Generating Low-Quality Images

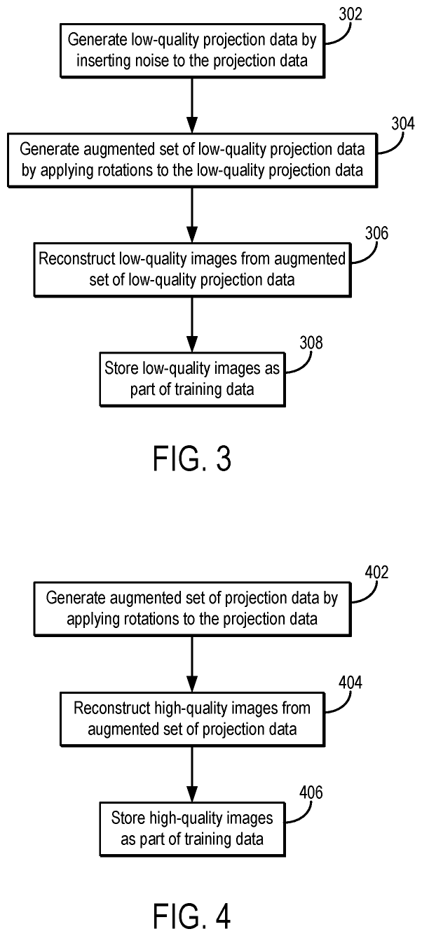

Referring now to FIG. 3, a flowchart is illustrated as setting forth the steps of an example method for generating low-quality images from projection data for self-training of a neural network or other machine learning algorithm.

Low-quality projection data are generated from the original projection data, as indicated at step 302. For instance, the low-quality projection data are generated by inserting noise to the original projection data. As a non-limiting example, independent noise insertion can be applied multiple times (e.g., 72 times) on the original projection data of a specific patient to generate the corresponding low-quality projection data (e.g., noise corresponding to 25% dose, 10% dose, etc.). The low-dose levels can be randomized during the process of noise insertion such that the low-quality projection data correspond to a single low-dose noise level and/or multiple different low-dose noise levels.

Augmented data are generated from the low-quality projection data by using one or more different data augmentation techniques, as indicated at step 304. For example, the augmented low-quality projection data can be generated by applying rotations to the low-quality projection data. Various different rotation angles can be directly applied on the projection data so that images generated from the rotated data are rotated at an arbitrary angle without introducing additional errors. As a non-limiting example, 72 different rotation angles (e.g., every 5 degrees over a range of 360 degrees) can be applied to the low-quality projection data.

Low-quality images are then reconstructed from the augmented low-quality projection data, as indicated at step 306. For instance, based on the preceding example, 72 sets of images with different rotation angles are obtained.

The low-quality images are stored for later use as part of training data, as indicated at step 308. In some embodiments, the low-quality images can be grouped into different groups, such as different groups based on the rotation angle applied to the underlying projection data during data augmentation. As a non-limiting example, the images can be grouped as follows: Group 1 {rotate 20*n degrees}, Group 2 {rotate 20*n+5 degrees}, Group 3 {rotate 20*n+10 degrees}, and Group 4 {rotate 20*n+15 degrees} for n=0, 1, 2, . . . , 17. In this example, the images in Group 2 are flipped on x-axis, and the images in Group 3 are flipped on y-axis. The choice of the number of groups and the division of rotation angles within each group can be selected based on the number and angular spacing of the rotation angles applied to the projection data during data augmentation.

### Generating High-Quality Images

Referring now to FIG. 4, a flowchart is illustrated as setting forth the steps of an example method for generating high-quality images from projection data for self-training of a neural network or other machine learning algorithm.

Augmented data are generated from the projection data by using one or more different data augmentation techniques, as indicated at step 402. For example, the augmented projection data can be generated by applying rotations to the projection data. Various different rotation angles can be directly applied on the projection data so that images generated from the rotated data are rotated at an arbitrary angle without introducing additional errors. As a non-limiting example, 72 different rotation angles (e.g., every 5 degrees over a range of 360 degrees) can be applied to the projection data. In some embodiments, noise can be inserted to the projection data before data augmentation. In these instances, the amount of noise inserted to the projection data would be less than the noise inserted when forming the low-quality projection data.

High-quality images are then reconstructed from the augmented projection data, as indicated at step 404. For example, 72 sets of images with different rotation angles are obtained. The high-quality images are “high quality” in the sense that they are higher quality as compared to the low-quality images (e.g., the high-quality images have less noise than the low-quality images).

The high-quality images are stored for later use as part of training data, as indicated at step 406. In some embodiments, the high-quality images can be grouped into different groups, such as different groups based on the rotation angle applied to the underlying projection data during data augmentation. As a non-limiting example, the images can be grouped similarly to the example groups described above with respect to examples of grouping low-quality images based on rotation angle. In general, a grouping of high-quality images can be constructed similar to the grouping, if any, of low-quality images.

### Form Training Data Set

Referring again to FIG. 2, after the low-quality images and high-quality images have been generated, the training data set is formed from these images, as indicated at step 210. For instance, forming the training data set can include matching pairs of low-quality and high-quality images. As a non-limiting example, low-quality images and high-quality images can be matched based on full image matrices, or based on patches of the images. For instance, low-quality and high-quality image patches with multiple slices (e.g., 64×64×7 voxels) can be formed and matched from the generated low-quality and high-quality images.

In some embodiments, the low-quality images and high-quality images can be paired based on the data augmentation performed when generating the images. For example, when the low-quality and high-quality images are generated based on applying a rotation angle to the underlying projection data, the low-quality and high-quality images can be paired based on that applied rotation angle.

Additionally or alternatively, the low-quality images and the high-quality images can each be arranged into groups of images, and pairs of low-quality and high-quality images within groups can be formed. As a non-limiting example, both the low-quality images and the high-quality images can be divided and arranged into four groups based on the rotation angle applied to the underlying projection data: Group 1 {rotate 20*n degrees, n=0, 1, 2, . . . , 17}, Group 2 {rotate 20*n+5 degrees}, Group 3 {rotate 20*n+10 degrees}, and Group 4 {rotate 20*n+15 degrees}. In this example, the images in Group 2 are flipped on x-axis, and the images in Group 3 are flipped on y-axis. The choice of the number of groups and the division of rotation angles within each group can be selected based on the number and angular spacing of the rotation angles applied to the projection data during data augmentation. Different groupings can also be formed based on different types of data augmentation (e.g., translation). In the preceding example, the images corresponding to the first three groups (Groups 1-3) can be used for model training and the images in the fourth group (Group 4) can be used for model validation.

### Train Neural Network

A neural network (or other suitable machine learning algorithm) is then trained on the training data, as indicated at step 212. In general, the neural network can be trained by optimizing network parameters (e.g., weights, biases, or both) based on minimizing a loss function. As one non-limiting example, the loss function may be a mean squared error loss function. In general, the neural network(s) can implement any number of different neural network architectures. For instance, the neural network(s) could implement a convolutional neural network (“CNN”), a residual neural network (e.g., a residual CNN), or the like. Alternatively, the neural network(s) could be replaced with other suitable machine learning algorithms.

Training a neural network may include initializing the neural network, such as by computing, estimating, or otherwise selecting initial network parameters (e.g., weights, biases, or both). Training data can then be input to the initialized neural network, generating output as noise-reduced images. The quality of the output noise-reduced images can then be evaluated, such as by passing the noise-reduced images to the loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. When the error has been minimized (e.g., by determining whether an error threshold or other stopping criterion has been satisfied), the current neural network and its associated network parameters represent the trained neural network.

### Store and Implement Neural Network

The trained neural network is then stored for later use, as indicated at step 214. Storing the neural network(s) may include storing network parameters (e.g., weights, biases, or both), which have been computed or otherwise estimated by training the neural network(s) on the training data. Storing the trained neural network(s) may also include storing the particular neural network architecture to be implemented. For instance, data pertaining to the layers in the neural network architecture (e.g., number of layers, type of layers, ordering of layers, connections between layers, hyperparameters for layers) may be stored.

Images of the subject are then reconstructed from the projection data, as indicated at step 216. These images will, in general, contain a higher level of noise than desired. As a non-limiting example, the images can be reconstructed using conventional image reconstruction algorithms, such as backprojection-based reconstructions. Alternatively, the images can be reconstructed using iterative image reconstruction techniques, model-based image reconstruction techniques, and so on.

The reconstructed images are then input to the trained neural network, generating output as noise-reduced images, as indicated at step 218. The noise-reduced images or improved medical image data may also be referred to as denoised images. For example, the noise-reduced images may include images of the subject that have been denoised, or in which noise has otherwise been reduced relative to the original corrupted projection data and/or images reconstructed therefrom in step 216.

The noise-reduced images generated by inputting the reconstructed images to the trained neural network(s) can then be displayed to a user, stored for later use or further processing, or both, as indicated at step 220.

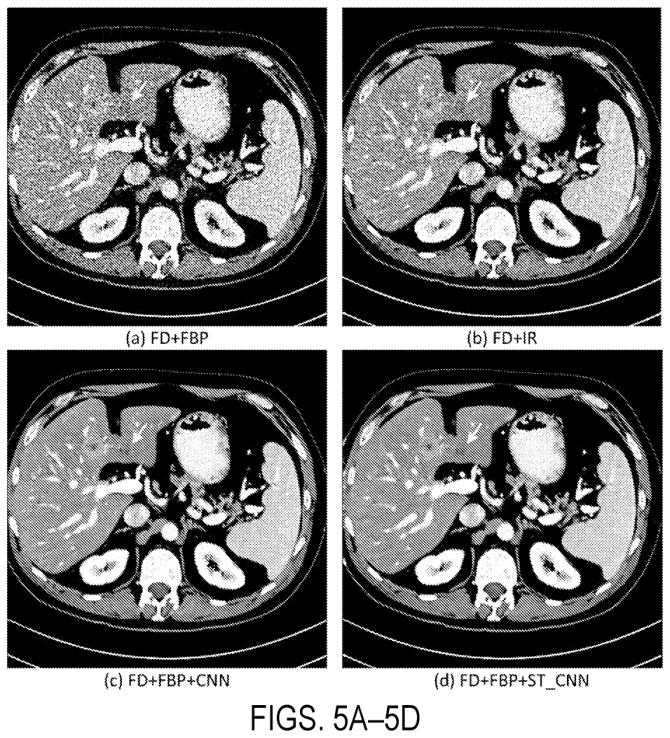

As a non-limiting example, a residual-based 2D CNN denoiser can be used, such as the residual-based CNN denoiser model shown in FIGS. 5A and 5B with 7 slices as input. FIG. 5A shows a global structure of the network containing a 2D initial block, three 2D residual blocks, and a final block. FIG. 5B provides details regarding the convolutional layers and transformations used within each block (Conv2D=two-dimensional convolutional layer, N=arbitrary image size, ReLU-rectified linear units).

To optimize the performance of the CNN model, a number of adjacent CT slices may be used as the channel input of the 2D residual CNN model. In the example shown in FIGS. 5A and 5B, seven adjacent CT slices are used as inputs to the residual-based CNN model. The CNN inputs may be standardized by subtracting the mean value and dividing by the standard deviation. Applying the standardized input to the initial 2D convolutional layer may then generate feature maps. The feature maps may be further processed by a series of 2D residual blocks, each of which included repeated 2D convolutional layers, batch normalization, and rectified linear unit activation. The filter number of each 2D convolutional layer was set to 128, and the kernel size of all layers was set to 3×3 with a stride of 1 in each dimension. The output of residual blocks was projected back to a single-channel image by using a single convolutional layer with 1 filter. This single-channel image was the estimated noise, which was further subtracted from the central input slice to get the final denoising result.

### EXAMPLES

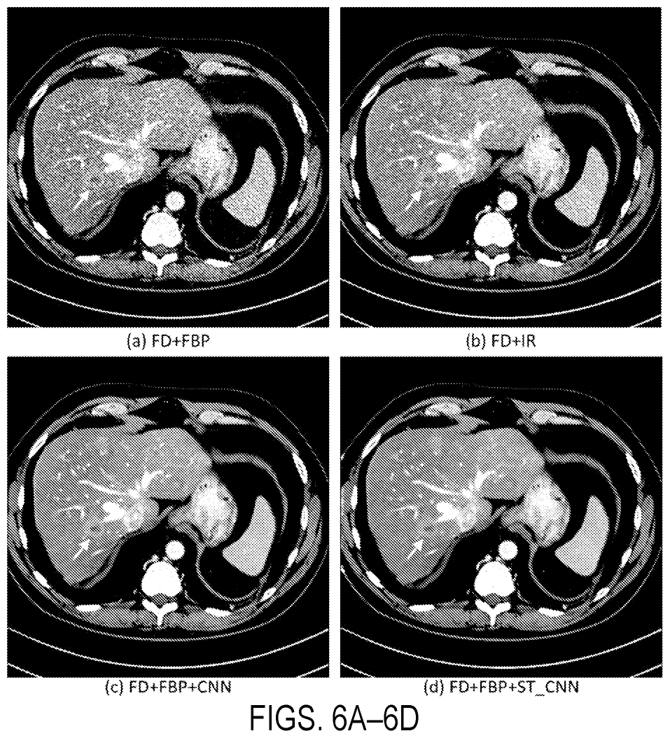

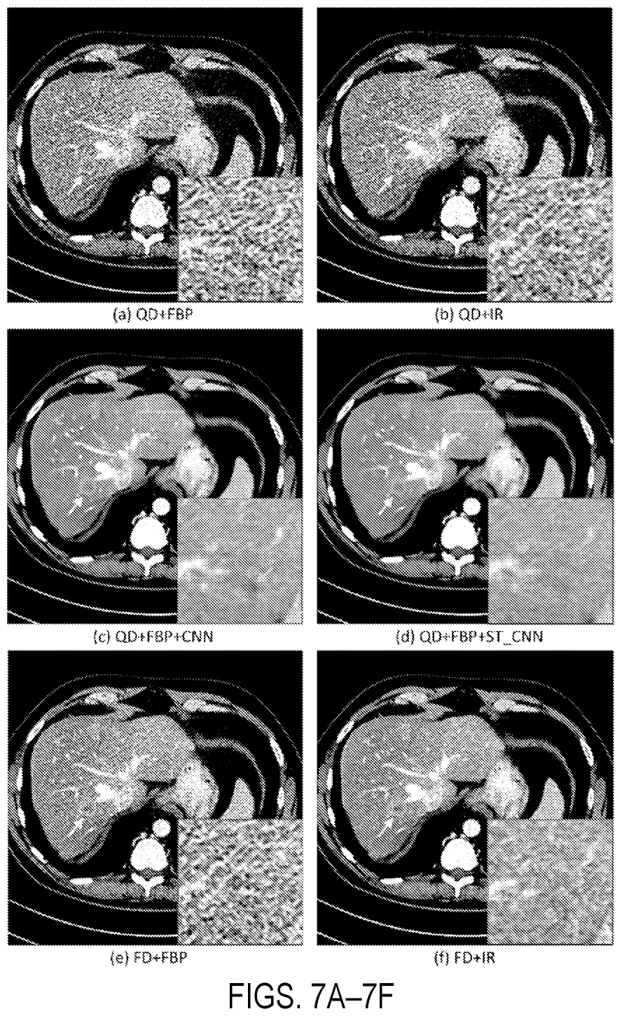

FIGS. 6A-6D and 7A-7D compare the filtered back projection (FBP) and iterative reconstruction (IR) based full dose (FD), conventional and self-trained CNN-denoised FBP FD images from a patient case. All images were reconstructed by FBP or IR algorithm using matched kernels of B30 and I30. The conventional CNN was trained and validated using FBP FD and FBP QD image pairs from 22 patient data (17 patients for training and 5 patients for validation) using a residual network-based method, which was modified from the original Residual Encoder-Decoder CNN (RED_CNN) method. The residual network architecture was identical to that used in the self-trained CNN (“ST_CNN”). The trained conventional CNN model was applied to denoise the FBP FD images of the rest of the patient data. The self-trained CNN was trained and validated using augmented FBP 10% dose and FBP FD image pairs of a specific patient, and then was applied to denoise the original FBP FD images of the same patient. The performances of two CNN models were assessed visually by an experienced radiologist. For the overall image quality evaluation, the radiologist ranked the self-trained CNN method better than the conventional one because of more homogeneous liver parenchyma and better low-contrast lesion visibility (arrows in the figure point to two subtle malignant liver tumors).

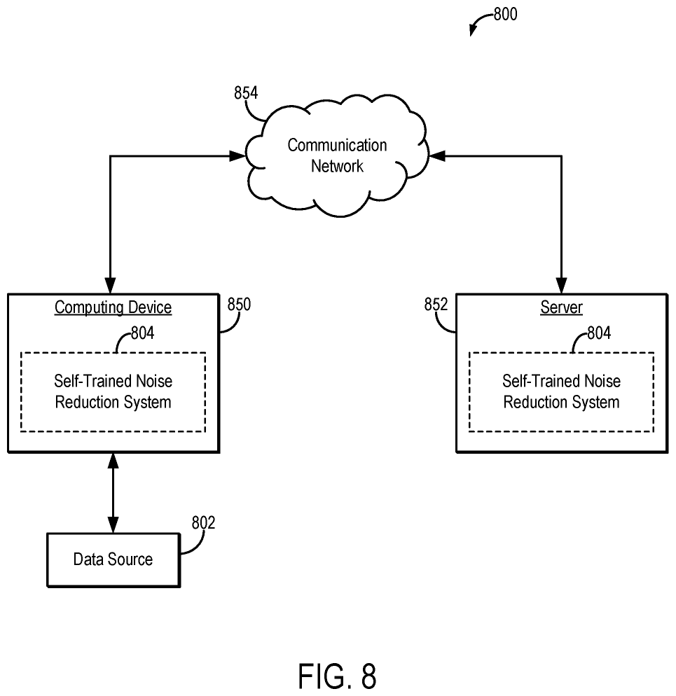

In order to use the FBP FD images as the reference standard for further evaluating the performance of CNN models, the self-trained CNN was trained and validated using augmented 10% dose (FBP) and QD (FBP) image pairs of a specific patient, and then was applied to denoise the FBP QD images of the same patient. The previous trained conventional CNN was used to denoise the same FBP QD images for CNN performance comparison. FIGS. 8A 8F compare the FBP and IR based quarter dose (QD), FBP and IR based full dose (FD), conventional and self-trained CNN-denoised FBP QD images from the same patient. All images were reconstructed using FBP with a B30f kernel and using IR with the matching I30f kernel. The performances of both CNN models were assessed visually by the experienced radiologist. In terms of low-contrast lesion visibility, conventional and self-trained CNN appeared to have a similar performance (arrows in the figure point to two subtle malignant liver tumors). For the overall image quality evaluation, the radiologist ranked the self-trained CNN method better than the conventional one because of more homogeneous liver parenchyma and less false positive structures (a zoomed-in ROI in the liver parenchyma corresponding to the green box is shown in the bottom-right).

Using the FBP FD reference image, the root mean square error (RMSE), peak signal-to-noise ratio (PSNR), and structural similarity (SSIM) were calculated for the conventional and self-trained CNN-denoised QD images. The results illustrate that the ST_CNN method has a performance similar to that of conventional deep CNN denoising methods without the need of a large number of training data.

### Computer Systems

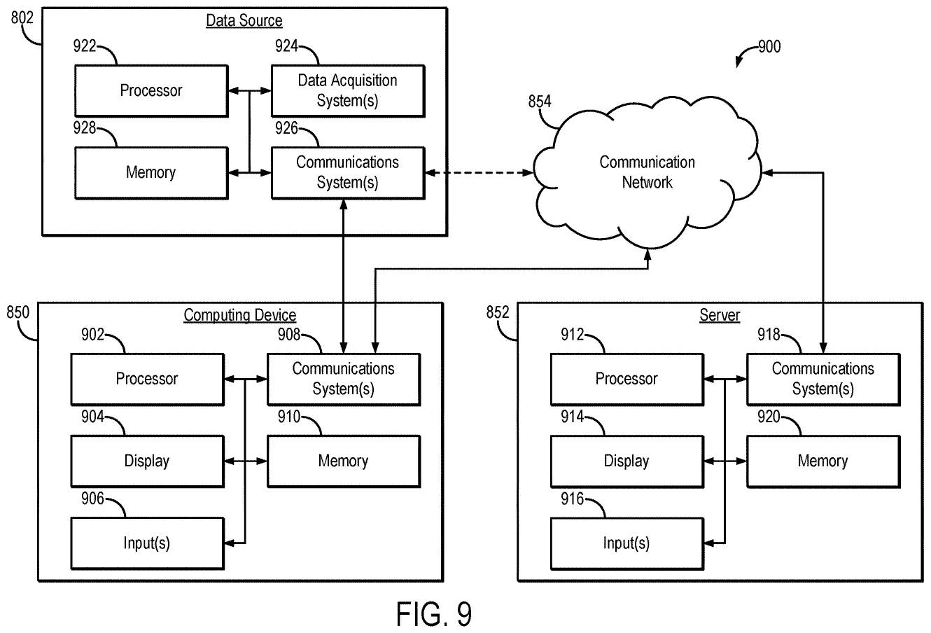

FIG. 9 illustrates an example of a system 900 for generating reduced noise images using a self-trained neural network or other machine learning algorithm, in accordance with some embodiments of the systems and methods described in the present disclosure. As shown in FIG. 9, a computing device 950 can receive one or more types of data (e.g., projection data, training data) from data source 902. In some embodiments, computing device 950 can execute at least a portion of a self-trained noise reduction system 904 to generate noise-reduced images using a neural network or other machine learning algorithm that is trained from data received from the data source 902.

Additionally or alternatively, in some embodiments, the computing device 950 can communicate information about data received from the data source 902 to a server 952 over a communication network 954, which can execute at least a portion of the self-trained noise reduction system 904. In such embodiments, the server 952 can return information to the computing device 950 (and/or any other suitable computing device) indicative of an output of the self-trained noise reduction system 904.

In some embodiments, computing device 950 and/or server 952 can be any suitable computing device or combination of devices, such as a desktop computer, a laptop computer, a smartphone, a tablet computer, a wearable computer, a server computer, a virtual machine being executed by a physical computing device, and so on. The computing device 950 and/or server 952 can also reconstruct images from the data.

In some embodiments, data source 902 can be any suitable source of data (e.g., x-ray projection data, images reconstructed from projection data, processed image data), such as a CT system, another computing device (e.g., a server storing projection data, images reconstructed from projection data, processed image data), and so on. In some embodiments, data source 902 can be local to computing device 950. For example, data source 902 can be incorporated with computing device 950 (e.g., computing device 950 can be configured as part of a device for measuring, recording, estimating, acquiring, or otherwise collecting or storing data). As another example, data source 902 can be connected to computing device 950 by a cable, a direct wireless link, and so on. Additionally or alternatively, in some embodiments, data source 902 can be located locally and/or remotely from computing device 950, and can communicate data to computing device 950 (and/or server 952) via a communication network (e.g., communication network 954).

In some embodiments, communication network 954 can be any suitable communication network or combination of communication networks. For example, communication network 954 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 954 can be a local area network, a wide area network, a public network (e.g., the Internet), a private or semi-private network (e.g., a corporate or university intranet), any other suitable type of network, or any suitable combination of networks. Communications links shown in FIG. 9 can each be any suitable communications link or combination of communications links, such as wired links, fiber optic links, Wi-Fi links, Bluetooth links, cellular links, and so on.

Referring now to FIG. 10, an example of hardware 1000 that can be used to implement data source 902, computing device 950, and server 952 in accordance with some embodiments of the systems and methods described in the present disclosure is shown.

As shown in FIG. 10, in some embodiments, computing device 950 can include a processor 1002, a display 1004, one or more inputs 1006, one or more communication systems 1008, and/or memory 1010. In some embodiments, processor 1002 can be any suitable hardware processor or combination of processors, such as a central processing unit (“CPU”), a graphics processing unit (“GPL”), and so on. In some embodiments, display 1004 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 1006 can include any suitable input devices and/or sensors that can be used to receive user input, such as a keyboard, a mouse, a touchscreen, a microphone, and so on.

In some embodiments, communications systems 1008 can include any suitable hardware, firmware, and/or software for communicating information over communication network 954 and/or any other suitable communication networks. For example, communications systems 1008 can include one or more transceivers, one or more communication chips and/or chip sets, and so on. In a more particular example, communications systems 1008 can include hardware, firmware, and/or software that can be used to establish a Wi-Fi connection, a Bluetooth connection, a cellular connection, an Ethernet connection, and so on.

In some embodiments, memory 1010 can include any suitable storage device or devices that can be used to store instructions, values, data, or the like, that can be used, for example, by processor 1002 to present content using display 1004, to communicate with server 952 via communications system(s) 1008, and so on. Memory 1010 can include any suitable volatile memory, non-volatile memory, storage, or any suitable combination thereof. For example, memory 1010 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 1010 can have encoded thereon, or otherwise stored therein, a computer program for controlling operation of computing device 950. In such embodiments, processor 1002 can execute at least a portion of the computer program to present content (e.g., images, user interfaces, graphics, tables), receive content from server 952, transmit information to server 952, and so on. For example, the processor 1002 and the memory 1010 can be configured to perform the methods described herein (e.g., the method of FIG. 2; the method of FIG. 3; the method of FIG. 4).

In some embodiments, server 952 can include a processor 1012, a display 1014, one or more inputs 1016, one or more communications systems 1018, and/or memory 1020. In some embodiments, processor 1012 can be any suitable hardware processor or combination of processors, such as a CPU, a GPU, and so on. In some embodiments, display 1014 can include any suitable display devices, such as an LCD screen, LED display, OLED display, electrophoretic display, a computer monitor, a touchscreen, a television, and so on. In some embodiments, inputs 1016 can include any suitable input devices and/or sensors that can be used to receive user input, such as a keyboard, a mouse, a touchscreen, a microphone, and so on.

In some embodiments, communications systems 1018 can include any suitable hardware, firmware, and/or software for communicating information over communication network 954 and/or any other suitable communication networks. For example, communications systems 1018 can include one or more transceivers, one or more communication chips and/or chip sets, and so on. In a more particular example, communications systems 1018 can include hardware, firmware, and/or software that can be used to establish a Wi-Fi connection, a Bluetooth connection, a cellular connection, an Ethernet connection, and so on.

In some embodiments, memory 1020 can include any suitable storage device or devices that can be used to store instructions, values, data, or the like, that can be used, for example, by processor 1012 to present content using display 1014, to communicate with one or more computing devices 950, and so on. Memory 1020 can include any suitable volatile memory, non-volatile memory, storage, or any suitable combination thereof. For example, memory 1020 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1020 can have encoded thereon a server program for controlling operation of server 952. In such embodiments, processor 1012 can execute at least a portion of the server program to transmit information and/or content (e.g., data, images, a user interface) to one or more computing devices 950, receive information and/or content from one or more computing devices 950, receive instructions from one or more devices (e.g., a personal computer, a laptop computer, a tablet computer, a smartphone), and so on.

In some embodiments, the server 952 is configured to perform the methods described in the present disclosure. For example, the processor 1012 and memory 1020 can be configured to perform the methods described herein (e.g., the method of FIG. 2; the method of FIG. 3; the method of FIG. 4).

In some embodiments, data source 902 can include a processor 1022, one or more data acquisition systems 1024, one or more communications systems 1026, and/or memory 1028. In some embodiments, processor 1022 can be any suitable hardware processor or combination of processors, such as a CPU, a GPU, and so on. In some embodiments, the one or more data acquisition systems 1024 are generally configured to acquire data, images, or both, and can include a CT system or other x-ray imaging system. Additionally or alternatively, in some embodiments, the one or more data acquisition systems 1024 can include any suitable hardware, firmware, and/or software for coupling to and/or controlling operations of a CT system or other x-ray imaging system. In some embodiments, one or more portions of the data acquisition system(s) 1024 can be removable and/or replaceable.

Note that, although not shown, data source 902 can include any suitable inputs and/or outputs. For example, data source 902 can include input devices and/or sensors that can be used to receive user input, such as a keyboard, a mouse, a touchscreen, a microphone, a trackpad, a trackball, and so on. As another example, data source 902 can include any suitable display devices, such as an LCD screen, an LED display, an OLED display, an electrophoretic display, a computer monitor, a touchscreen, a television, etc., one or more speakers, and so on.

In some embodiments, communications systems 1026 can include any suitable hardware, firmware, and/or software for communicating information to computing device 950 (and, in some embodiments, over communication network 954 and/or any other suitable communication networks). For example, communications systems 1026 can include one or more transceivers, one or more communication chips and/or chip sets, and so on. In a more particular example, communications systems 1026 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 1028 can include any suitable storage device or devices that can be used to store instructions, values, data, or the like, that can be used, for example, by processor 1022 to control the one or more data acquisition systems 1024, and/or receive data from the one or more data acquisition systems 1024; to generate images from data; present content (e.g., data, images, a user interface) using a display; communicate with one or more computing devices 950; and so on. Memory 1028 can include any suitable volatile memory, non-volatile memory, storage, or any suitable combination thereof. For example, memory 1028 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1028 can have encoded thereon, or otherwise stored therein, a program for controlling operation of data source 902. In such embodiments, processor 1022 can execute at least a portion of the program to generate images, transmit information and/or content (e.g., data, images, a user interface) to one or more computing devices 950, receive information and/or content from one or more computing devices 950, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for generating noise-reduced medical images, the method comprising:
(a) accessing projection data with a computer system, wherein the projection data comprise x-ray projection data acquired from a subject using a computed tomography (CT) system;
(b) generating training data from the projection data using the computer system, wherein generating the training data comprises:
generating a set of low-quality projection data by inserting noise to the projection data in different independent insertions;
generating augmented low-quality projection data by applying a data augmentation technique to the low-quality projection data;
reconstructing low-quality images from the augmented low-quality projection data;
generating augmented projection data by applying the data augmentation technique to the projection data; and
reconstructing high-quality images from the augmented projection data;
wherein the low-quality images and the high-quality images comprise the training data;
(c) training a neural network on the training data;
(d) reconstructing images of the subject from the projection data; and
(e) applying the reconstructed images of the subject to the trained neural network, generating output as the noise-reduced images of the subject.

2. The method of claim 1, wherein the data augmentation technique comprises applying rotations to the low-quality projection data and the projection data.

3. The method of claim 2, wherein the rotations are applied in an angular increment less than 360 degrees.

4. The method of claim 1, wherein generating the set of low-quality projection data by inserting noise to the projection data in different independent insertions comprises inserting noise at a selected dose noise level corresponding to a dose value that is lower than a dose used to acquire the projection data.

5. The method of claim 4, wherein the selected dose noise level corresponds to a 10 percent dose relative to the dose used to acquire the projection data.

6. The method of claim 4, wherein the selected dose noise level corresponds to a 25 percent dose relative to the dose used to acquire the projection data.

7. The method of claim 1, wherein generating the training data comprises pairing low-quality images with high-quality images based on the data augmentation technique.

8. The method of claim 7, wherein the data augmentation technique comprises applying rotations to the low-quality projection data and the projection data and low-quality images are paired with high-quality images based on rotation angle used during data augmentation.

9. The method of claim 7, wherein pairing the low-quality images and high-quality images comprises matching image patches in the low-quality images with image patches in the high-quality images.

10. The method of claim 1, wherein generating the training data comprises grouping low-quality images and high-quality images into different groups based on the data augmentation technique.

11. The method of claim 10, wherein the data augmentation technique comprises applying rotations to the low-quality projection data and the projection data, and the low-quality images and high-quality images are grouped based on rotation angle used during data augmentation.

12. The method of claim 10, wherein at least one of the different groups is selected for validation of the trained neural network.

13. The method of claim 1, wherein the neural network is a convolutional neural network.

14. The method of claim 13, wherein the convolutional neural network is a residual convolutional neural network.

15. The method of claim 1, further comprising inserting noise to the projection data before applying the data augmentation technique to the projection data to generate the augmented projection data.

16. The method of claim 15, wherein the amount of noise inserted to the projection data is less than the noise inserted when forming the low-quality projection data.
